(19) United States
(12) Patent Application Publication
(10) Pub. No.: US 2008/0237303 A1
(43) Pub. Date: Oct. 2, 2008

(54) Decision method for dressing of welding electrodes

(75) Inventors: Zhongqin Lin, Shanghai (CN); Pei-Chung Wang, Troy, MI (US); Xinmin Lai, Shanghai (CN); Yansong Zhang, Shanghai (CN); Guanlong Chen, Shanghai (CN); Peter C. Sun, Shanghai (CN)

Correspondence Address: GENERAL MOTORS CORPORATION;LEGAL STAFF, MAIL CODE 482-C23-B21, P O BOX 300, DETROIT, MI, 48265-3000, US

(73) Assignees: GM Global Technology Operations, Inc., Detroit, MI (US); SHANGHAI JIAOTONG UNIVERSITY, SHANGHAI (CN)

(21) Appl. No.: 11/692,525

(22) Filed: Mar. 28, 2007

(51) Int. Cl. B23K 31/12

(52) U.S. Cl. 228/103

(57) ABSTRACT

A method is provided for determining that the electrodes of an electric resistance welder are in need of replacement and dressing includes monitoring the rate at which the depth of the weld indentation caused by the electrode changes during the progressive wearing of the electrodes during the making of successive welds. The electrodes are then dressed when it is determined that the rate of change of the depth of the weld indentation formed by the electrodes has substantially leveled off to a stable depth of indentation.

### FIELD OF THE INVENTION

The present invention relates to a method for determining the need to dress the tip of welding electrodes in an electric resistance spot welding process.

### BACKGROUND OF THE INVENTION

The construction of automotive bodies and other manufactured products often requires the formation of many uniformly sized electrical resistance spot welds. The welds are made by bringing assemblies of sheet metal parts to a welding station where a computer controlled robot, or other welding machine, systematically and sequentially forms a series of spot welds to attach the sheet metal parts of the sheet metal assembly.

The welding is performed using a weld gun typically having copper or copper alloy welding electrodes. One electrode is a fixed electrode and the other electrode is a movable electrode. The electrodes are axially aligned in opposition to each other, at a specified spot weld site, and the movable electrode is advanced to clamp and press the sheets against the fixed electrode. A large electric current is momentarily passed between the opposing electrodes through the electrically resistive metal sheets pressed between the electrodes. The sheet metal between the electrodes is briefly fused during current flow and then re-solidifies to form an integral weld nugget of suitable diameter at the abutting surfaces of the sheet metal layers. In such a manufacturing operation, scores or hundreds of such welds are rapidly formed. The goal is to form all of the welds to substantially the same size, within an acceptable tolerance value, and with minimal internal porosity or discontinuities.

Welding controllers are used to control the force applied by the electrodes and to control the weld current and its duration. The force applied to the welding site by the electrodes and the resistive heat generated by the welding current results in an indentation caused by the displacement of the electrode into the softened welded surface of the sheets at the location of the weld nugget. In setting up the welding machine to produce a series of uniform welds, initial values of suitable electrode force, total welding current, and its duration are established for the welding gun and the specific metal sheets. The welding controller can be programmed in an attempt to maintain these values so that the same welds are produced during extended manufacturing operations.

However, it is known that variations creep into the welding operation because of electrode wear. In particular, as the welding operation proceeds, the tips of the electrodes are progressively deformed and mushroomed in shape and must eventually be dressed, either by hand or by machine, to remove the mushroomed copper from the weld tip and restore the original tapered shape. After a number of such dressings the electrodes will become so shortened in length and consumed that they must be replaced with new electrodes.

Weld nugget uniformity and quality can be confirmed off-line from the production operation by periodically removing the sheets from the operation and physically examining and testing a number of weld nuggets. By conducting a number of such tests at varying degrees of electrode wear, a process engineer can make a decision to dress the electrodes every certain number of welds, for example every 200 welds, and this dressing criteria is established with a considerable margin of error in order to assure quality welds.

It would be desirable to have an on-line process that could be performed during welding operations to monitor and assess welding conditions and correlate them to the condition of the electrode tip and determine the need to dress the electrode tips and/or replace the electrode tips.

### SUMMARY OF THE INVENTION

A method is provided for determining that the electrodes of an electric resistance welder are in need of replacement and dressing. The method monitors the rate at which the depth of the weld indentation caused by the electrode changes during the progressive wearing of the electrodes during the making of successive welds. The electrodes are then dressed when it is determined that the rate of change of the depth of the weld indentation formed by the electrodes has substantially leveled off to a stable depth of indentation.

### DESCRIPTION OF THE DRAWINGS

FIG. 1 is a schematic diagram of a side view of a representative spot welding gun apparatus with the associated equipment and controllers used in spot welding operations;

FIG. 2 is an enlarged fragmentary sectional view of two sheet metal parts attached with a spot weld nugget of diameter D, and indentation I;

FIG. 3 is an enlarged fragmentary view of FIG. 1 showing the electrodes with no wear;

FIG. 4 is an enlarged fragmentary view similar to FIG. 3 but showing the electrodes with wear;

FIG. 5 is a plot of the depth of indentation versus number of welds; and,

FIG. 6 is a flow diagram illustrating an embodiment of the control process for determining the need for dressing or replacement of the weld electrodes.

### DESCRIPTION OF A PREFERRED EMBODIMENT

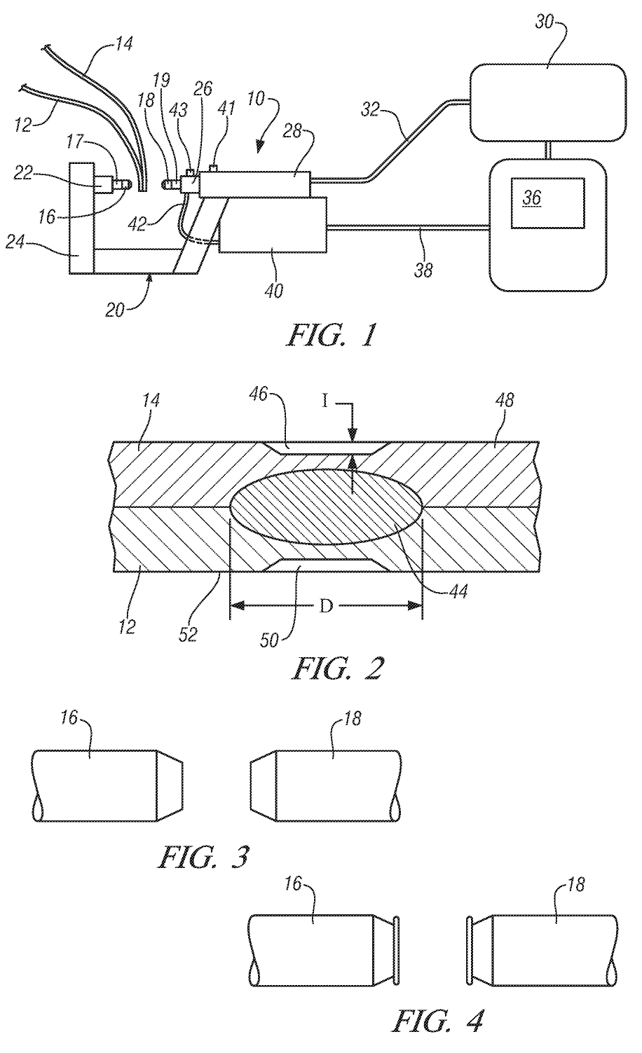

Referring to FIG. 1, a schematic illustration of a side view of a representative spot welding gun apparatus 10 is shown. In such an operation, an assembly of two or more sheet metal layers to be welded is prepared at a suitable location and transported by means, not shown, to the welding gun apparatus 10. In this example, the assembled sheets consist of sheets 12 and 14 of formable commercial steel. The assembled sheets 12 and 14 may, for example, be previously stamped inner and outer panels for a vehicle body.

The weld gun apparatus 10 includes a fixed electrode 16 mounted on a shank 17 inserted in a holder 22, which is attached to a fixed arm 24 of a welding gun arm 20. A movable electrode 18 is mounted on a shank 19 and inserted in a holder 26 carried in a servomotor drive 28. Servomotor drive 28 is adapted to axially move the movable electrode 18 into clamping engagement with the sheet 14 and press and clamp the sheet 12 into clamping engagement with the sheet 12.

The welding gun arm 20, shown in FIG. 1, may be stationary or it may be mounted on the end of a robot arm or other conventional multi-axis manipulator.

A process controller 30 is provided for precisely controlling the servomotor drive 28 as well as controlling the robot or other multi axis manipulator that mounts the welding apparatus 10. The process controller 30 is connected to the servomotor drive 28 by conductor cable 32. An encoder 41 is associated with the servomotor drive 28 and accurately monitors the motion of the movable electrode 18. A load cell 43 is provided within the electrode holder 26, or elsewhere, to detect the amount of force that is exerted upon the sheets 12 and 14 by the electrodes 16 and 18.

A welding controller 36 is provided for controlling and monitoring the welding apparatus 10. A cable 38 connects the welding controller 36 to a weld transformer 40, and a cable 42 connects the weld transformer 40 to the electrode holder 26.

In operation, process controller 30 will activate the servomotor drive 28 to move the electrode 18 into engagement with the sheet 14, and move the sheet 14 into engagement with the sheet 12, so that the sheets 12 and 14 are clamped between the electrodes. The welding controller 36 then regulates the passage of a primary welding current from a remote source, not shown. The welding energy source may be 60 Hz, high voltage, low current alternating current. Upon command of welding controller 36, the primary current is delivered through cable 38 to weld transformer 40. Weld transformer 40 converts the primary current to a lower voltage, but higher current. Furthermore, the alternating current may be converted by a suitable rectifier to a direct current for welding. The secondary welding current is provided to electrode 18 through cable 42. The electrode 16 is connected to the opposite pole of the weld transformer via the electrode holder 22 and arm 20. The welding current may be of the order of 5,000 to 45,000 amperes depending upon the requirements of the welding operation. Where 60 cycle alternating current is initially provided, the total welding time for a typical spot weld may, e.g., be from 5 to 40 cycles of the 60 Hertz current.

When movable electrode 18 has been brought into contact with sheet 14, controller 30 initiates the spot weld operation and weld current is delivered through electrodes 18 and 16 as the servomotor drive 28 advances the movable electrode 18 during welding for the purpose of applying a predetermined squeeze force on sheets 12 and 14.

A typical spot weld nugget 44 joining sheets 12 and 14 is shown in the enlarged, fragmentary sectional view of FIG. 2. The nugget 44, elliptical in cross section, is formed at the abutting surfaces of sheets 12 and 14. The upper surface 48 of sheet 14 is slightly depressed at indented surface 46 below the level of upper surface 48. This indentation, indicated at “I”, from upper surface 48 to indented surface 46 results from the welding force applied by movable electrode 18 and its displacement into the weld heat softened metal of the sheet 14. Indented surface 46 is like a footprint of the tip of movable electrode 18. Similarly, a lower indented surface 50 of sheet 12 is formed on its bottom surface 52 due to the reactive force of fixed electrode 16.

The tip of electrode 18 is usually round and nugget 44 has a diameter, indicated at D, in FIG. 2. Indentation (I) can be measured by determining the distance advanced by the servomotor 28 from the time electrode 18 just contacts surface 48 until the completion of the weld.

FIG. 3 shows the tapered shape of the electrodes 16 and 18 with no wear. FIG. 4 shows the wear or mushrooming of the electrodes 16 and 18 as the electrodes progressively deform over the formation of successive welds. As the electrodes 16 and 18 are progressively worn, the surface area of the tip of the electrode increases, and accordingly the current density is decreased. This decrease in current density is known to affect the quality characteristics of the resulting spot weld. Thus the prior art has proposed altering the weld current provided by the welding current controller in order to compensate for the decrease in current density. However, at some point, it is necessary to either dress the electrodes to restore the more pointed shape of FIG. 3, or to replace the electrodes with new electrodes if the wear has progressed to such a point that dressing of the electrode tips is no longer practical. In order to assure that weld quality is maintained, it is common to dress the electrodes more frequently than might be necessary in order to err on the side of caution. For, example, every 200 welds for resistance welding of sheet steel, the welding process can be halted to permit the dressing of the electrodes in order to assure weld quality.

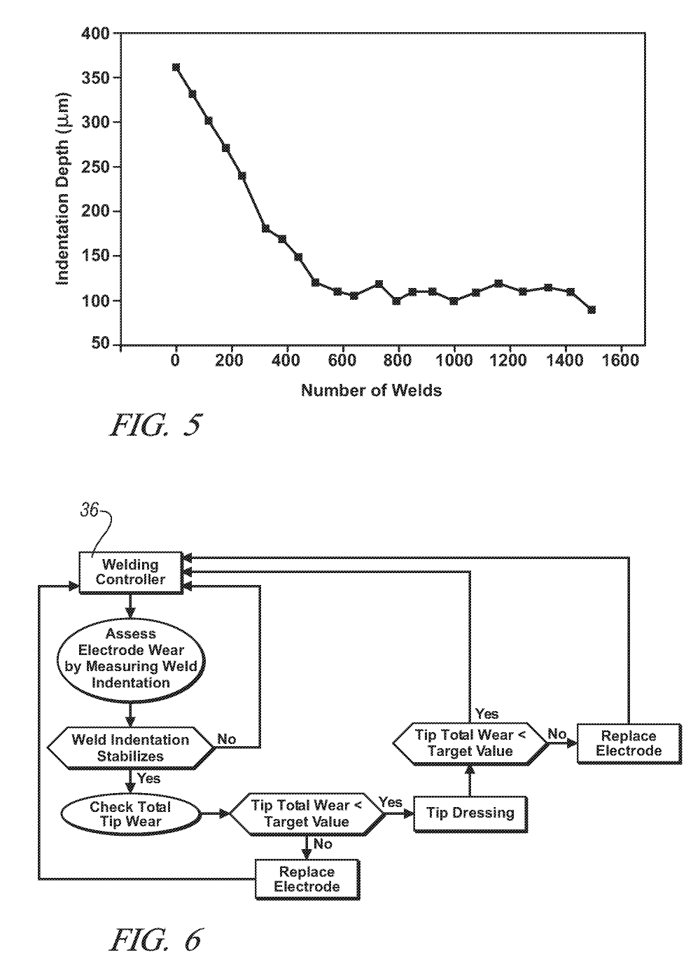

Referring to FIG. 5, we have discovered that beginning with a new or newly dressed electrode, the depth of the weld indentation decreases progressively with the number of welds, and then the depth of the weld indentation will stabilize. In particular, the curve of FIG. 5 displays the indentation depth versus number of welds for a particular welding process in which the sheets are 0.8 mm thick galvanized DP600 Steel, and the welder operates at 10 kilo amperes, 10 cycles and an electrode force of 220 kilograms. As seen in FIG. 5, the measured depth of the indentation begins to stabilize at about 500 to 600 welds. Upon testing of welds performed in this range of up to 600 welds, we have found that the weld strength is consistently acceptable and we have concluded therefrom that if the dressing or replacement of the weld tip is performed at or near the number of welds obtained where the indentation begins to stabilize, a successful decision can be made to stop the welding process and dress the electrodes, without any risk to obtaining quality welds.

Accordingly, FIG. 6 is a flow chart for making a decision to either dress the electrodes or to replace the worn electrodes with new electrodes. The decision process is programmed into the welding controller 36, and/or the process controller 30. Process controller 30 collects data from the encoder 41 associated with the servomotor 28 and the load cell 43 associated with electrode holder 26 in order to assess electrode wear by measuring the weld indentation. The load cell 43 is loaded when the electrode 18 has advanced sufficiently to begin squeezing the sheets 12 and 14 between the electrodes 16 and 18. Electrode displacement, and thus the total weld indentation in the sheets 12 and 14, is determined by taking the difference between the position of electrode holder 26 at the start of the welding operation and the position of the electrode holder 26 at the end of the welding operation, as measured by the encoder 41. This measurement can be taken every weld cycle, or, alternatively every 5 or 10 welds. The welding controller compares the indentation readings during successive welds and an algorithm is employed to determine that the indentation depth has stabilized, that is, the rate of change of the depth of weld indentation between successive welds has leveled off. If the indentation depth has not yet leveled off, the welding controller continues to initiate a further weld cycle to make another weld. If the indentation depth has leveled off, the process controller 30 will then terminate the welding process. The length of the electrodes is then checked to assure that the electrodes have sufficient remaining length to warrant dressing. This checking of the electrode length may be performed, for example, by comparing the length as measured by analysis of data from the encoder 41 with a target length as stored in the program of welding controller 36. If the electrode length is less than the target length, the electrodes are replaced, either manually or by automated equipment. If the electrode length is longer than the target length, the electrodes will be dressed, either manually or via automatic tip dressing equipment that is commercially available. After the electrodes are dressed, the electrodes are again measured for length, and replaced in the event that the dressing operation has caused the electrodes to become shorter than the target length.

It will be appreciated that the process controller 30 and the weld controller 36 each have hardware and software capable of control, memory storage, and electronic interface, and may typically include a microprocessor, a micro-controller, an application specific integrated circuit, and the like. The various process steps of FIG. 6 are performed by the cooperation of the process controller 30 and the weld controller 36, and particular process steps can be performed in either controller as will be recognized by a person of ordinary skill.

As alternative to measuring the beginning and end location of the movable electrode, it may be desirable to simply record the ending location of each successive weld, and to then determine the rate of change in the end location as this measurement will also enable an algorithm to analyze the rate of change and find the point where the rate of change begins to level off.

Thus the invention enables the manufacturing plant to obtain manufacturing efficiencies and high quality by determining the need to dress or replace the welding electrodes via an on-line monitoring process.

What is claimed is:

1. A method for determining whether electrodes of an electric resistance welder are in need of replacement and dressing, comprising:
monitoring the rate at which the depth of a weld indentation caused by electrode changes during the progressive wearing of the electrodes during the making of successive welds;
determining whether the rate of change of the depth of the weld indentation has substantially leveled off to a stable depth of indentation;
and dressing the electrodes in response to the determined substantial leveling off of the change in the depth of indention.

2. The method of claim 1 further comprising after dressing of the electrodes, comparing the length of the dressed electrodes with a target length value and replacing the electrodes if the length is less than the target length value.

3. The method of claim 1 further comprising before dressing the electrodes, comparing the length of the electrodes with a target length value and if the length is less than the target length value then replacing the electrodes.

4. The method of claim 1 further comprising before dressing and after dressing the electrodes, comparing the length of the electrodes with a target length value and replacing the electrode in the event that the target length is less than the target length value.

5. The method of claim 1 further comprising one of the electrodes being a movable electrode operated by a servomotor drive and the monitoring of the rate at which the depth of the weld indentation caused by the electrode changes during the progressive wearing of the electrode during the making of successive welds is performed by monitoring the position of the movable electrode.

6. The method of claim 5 further comprising the position of the moveable electrode being monitored by an encoder associated with the servomotor drive.

7. A method for determining whether a movable electrode and a fixed electrode of an electric resistance welder used to weld together workpieces are in need of replacement and dressing, comprising:
clamping a workpiece between the fixed electrode and the movable electrode by advancing the movable electrode;
performing the welding operation by conducting electrical current through the electrodes while simultaneously advancing the movable electrode;
measuring the travel of the movable electrode relative to the fixed electrode to thereby determine the depth of the weld indentation formed in the workpieces;
and stopping the welding operation and dressing the electrodes when it is determined that the rate of change of the depth of the weld indentation caused by the electrode wear during the making of successive welds has substantially leveled off to a stable depth of indentation.

8. The method of claim 7 further comprising the movable electrode being advanced by a servomotor drive having an encoder enabling measurement of the travel of the movable electrode.

9. The method of claim 8 further comprising a load cell associated with one of the electrodes.

10. The method of claim 9 further comprising the encoder and the load cell providing data to a controller for measuring the travel of the movable electrode during the making of successive weld and determining that the rate of change in the depth of the indentation has substantially leveled off.

11. The method of claim 7 further comprising measuring the length of the electrodes prior to dressing the electrodes and replacing the electrodes rather than dressing the electrodes if the length of the electrodes is less than a target value indicating the electrode are too much worn to be dressed.

12. The method of claim 7 further comprising: measuring the length of the electrodes after dressing the electrodes and replacing electrodes if the length of the dressed electrodes is less than a target value indicating the dressed electrodes are too much worn and shortened to be used to make further welds.
